(19) United States
(12) Patent Application Publication
(10) Pub. No.: US 2008/0191137 A1
(43) Pub. Date: Aug. 14, 2008

(54) Methods and apparatus for molecular species detection, inspection and classification using ultraviolet to near infrared Enhanced Photoemission Spectroscopy

(75) Inventors: Wade Martin Poteet, Vail, AZ (US); James Ryles, Tuscon, AZ (US); Malcolm Howard Philips, Tuscon, AZ (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CDEX, Inc.

(21) Appl. No.: 11/822,020

(22) Filed: Jun. 29, 2007

Related U.S. Application Data
(60) Provisional application No. 60/817,101, filed on Jun. 29, 2006.

(51) Int. Cl. G01J 1/42

(52) U.S. Cl. 250/338.1; 250/372

(57) ABSTRACT

The invention relates generally to the field of substance and material detection, inspection, and classification at wavelengths between approximately 200 nm and approximately 1800 nm. In particular, a handheld Enhanced Photoemission Spectroscopy (“EPS”) detection system with a high degree of specificity and accuracy, capable of use at small and substantial standoff distances (e.g., greater than 12 inches) is utilized to identify specific substances (e.g., controlled substances, illegal drugs and explosives, and other substances of which trace detection would be of benefit) and mixtures thereof in order to provide information to officials for identification purposes and assists in determinations related to the legality, hazardous nature and/or disposition decision of such substance(s).

### CROSS REFERENCE TO RELATED APPLICATIONS

This application claims priority under 35 U.S.C. §119 to U.S. Patent Application No. 60/817,101, filed Jun. 29, 2006, which application is expressly incorporated herein by reference in its entirety.

### BACKGROUND OF THE INVENTION

1. Field of the Invention

The invention relates generally to the field of substance and material detection, inspection, and classification at wavelengths between approximately 200 nm and approximately 1800 nm. In particular, a handheld Enhanced Photoemission Spectroscopy (“EPS”) detection system with a high degree of specificity and accuracy, capable of use at small and substantial standoff distances (e.g., greater than 12 inches) is utilized to identify specific substances (e.g., controlled substances, illegal drugs and explosives, and other substances of which trace detection would be of benefit) and mixtures thereof in order to provide information to officials for identification purposes and assists in determinations related to the legality, hazardous nature and/or disposition decision of such substance(s).

Generally, rigid molecular structures with delocalized electrons are good candidates for the EPS photoemission method described herein. To illustrate the interaction with a typical chemical species at the shorter wavelengths, the process in certain peroxide-based explosives is described as follows: The carbon-oxygen bonds between the O—O bonds in DADP or TATP, for example, provide an environment that allows sufficient absorption by a short wavelength energy source to produce a reasonable amount of photoemission at a slightly longer wavelength for detection. Table 3 (below) illustrates the chemical structure of two forms of common peroxide-based explosives.

TABLE 1

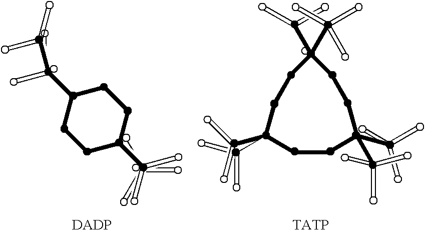

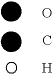

It should be noted that the energy and flux involved in the described processes pose no danger of destabilizing the molecule and triggering an explosion. These explosives are also known variously as peroxyacetone, acetone peroxide (cyclic trimer) TCAP (tri-cyclic acetone peroxide), and TATP. TATP is prepared by mixing hydrogen peroxide with acetone using a small amount of acid as a catalyst. The cyclic dimer (C₆H₁₂O₄) and open monomer and dimer are also formed, but under usual circumstances the cyclic trimer is the primary product. In mildly acidic or neutral conditions, the reaction is much slower and produces more monomeric organic peroxide than the reaction with a strong acid catalyst. Due to significant strain of the chemical bonds in the dimer and especially the monomer, they are even more unstable than the trimer.

One danger posed by these explosives is that law enforcement officials usually do not have pre-knowledge of the composition of “white powders” found at crime scenes and drug busts, and thus they cannot assess the threat to personnel at the scene. TATP, for example, is often found at the same laboratory site where illicit drugs are manufactured. TATP poses a particularly serious threat because at room temperature, the trimeric form (TATP) slowly sublimes, reforming as the less stable, more sensitive dimer. Since pre-knowledge of the manufacture time is not generally known, the early detection with a convenient handheld device is essential for the safety of investigative personnel and law enforcement.

In this regard, the Arson and Explosives Programs Division, BATFE, issued guidelines on Apr. 19, 2002 (FR Doc. 02-10324) advising all law enforcement officers to use extreme caution in executing drug enforcement operations. This warning is due to the fact that many illicit drug labs also fabricate peroxide-based explosives, and the warning continues by stating, “If you try to test the material in a field drug test kit, it will instantaneously detonate . . . TATP and HMTD . . . ” These substances can appear as cocaine, methamphetamine, or crack cocaine in the process of being produced, so handling them in any fashion for testing purposes is problematic. The difference between handling these homemade explosives (“HME”) and/or an illicit drug could be life or death unless a portable detector is available to the officers at the scene.

Similarly, as recently as Aug. 12, 2005, the United States Department of Homeland Security sounded the alarm by releasing an unclassified Joint Information Bulletin to the Department of Homeland Security, the Intelligence Community, Federal Departments and Agencies, State Homeland Security Advisors, Security Managers, State and Local Law Enforcement, International Partners, and Information Sharing and Analysis Centers (ISACs) concerning peroxide-based explosives. This document elevated the concern over the growing use of “peroxide-based” explosive products by terrorists in, for example, the recent London bombings, the suicide bombs used by Palestinian terrorist groups, the Dec. 22, 2001 shoe bomber Richard Reid, and the TATP and ammonium nitrate used in the suicide bombs deployed in Casablanca, Morocco, on May 16, 2003.

The Joint Bulletin makes it abundantly clear that our nation and the world have a new and growing challenge. Every transportation system (e.g., airport, train and bus terminal) or public gathering site (e.g., offices, stadiums and large meeting sites) is a potential target for terrorists using this type of easily constructed explosive device. Unfortunately, we have no portable, easy to use and non-invasive technology that can act as an offensive detection device that will quickly alert us to the presence of peroxide-based explosives.

Signal processing of the spectrally detected information can include a number of different modes and is important to utilizing whichever components of the (three-part) EPS process are involved in a particular detection. In one mode, for example, the output of the spectral detector(s) is digitized and the signal is processed in the local computer to derive a “detected” or “not detected” indication. Another method uses square-wave modulation of the light source to produce a photoemission that can be detected with a phase-sensitive circuit that provides additional separation of unwanted background signals from the signal of interest.

Substances that lend themselves to detection by the described invention include, but are not limited to: methamphetamine, cocaine, heroin, hashish, marijuana, prescription drugs in non-medical use, hallucinogenic compounds, explosives, toxic and dangerous chemicals and/or pharmaceuticals generally. Potential applications of the invention may include, but are not limited to law enforcement, probable cause for legal search determination, drug manufacture site cleanup verification, first responders, hazardous chemical determination, presence of drugs and/or precursors and/or presence of explosives, including peroxide-based chemicals.

In this regard, a recent survey indicates that illicit drug use and manufacture is on the rise in the U.S., and Table 2 illustrates use by category of illicit drugs in the year 2003.

Not included in these statistics is the increasing use of methamphetamine and its dangerous manufacture in “home” laboratories.

2. Discussion of the Related Art

Ultraviolet to Near Infrared (“UV to NIR”) EPS is an analytical technique used to identify and characterize chemical and biological materials and compositions. Modern light sources and detectors have made true handheld operation (as opposed to “transportable”) possible, and unique signal processing techniques increase sensitivity of these systems to allow detection of trace amounts of materials on surfaces. In operation, UV to NIR EPS systems direct energy (in the form of concentrated photons) from an excitation source toward a target area using, for example, reflective and/or refractive optics. Photoelectric and other interactions of the photons with the sample material produce detectable wavelength-shifted emissions that are typically at longer wavelengths than the absorbed excitation UV to NIR photons, and specular reflection or absorption produces selected wavelength-specific portions of the originating energy.

The first process involves a wavelength shift that is due to an energy transfer from the incident photons (at a specific wavelength) to the target materials. The transferred energy causes some of the sample's electrons to either break free or enter an excited (i.e., higher) energy state. Thus, these excited electrons occupy unique energy environments that differ for each particular molecular species being examined. As a result, electrons from higher energy orbital states “drop down” and fill orbitals vacated by the excited electrons. The energy lost by the electrons going from higher energy states to lower energy states results in an emission spectrum unique to each substance. When this process occurs in a short time, usually 100 nanoseconds or less, the resultant photon flux emission is referred to as fluorescence, although luminescence, phosphorescence, and photoluminescence are frequently used to describe these processes as well. The second process involves scattering of the incident energy by the target material due to its vibrational state; this process is known as Raman scattering, and occurs in a relatively narrow band of wavelengths that result from the incident energy being in the correct range to excite the phenomenon. The third component of EPS involves specular reflection or absorption from the surface of the target material so that only selective portions of the incident energy spectrum are reflected, while others are absorbed. These three processes occur to varying degrees in the methods described in this invention, and the target material itself defines to what level each process contributes to the final return spectrum analysis.

The resultant emission spectrum generated is detected with a spectrograph, digitized and analyzed (i.e., wavelength discrimination) using unique algorithms and signal processing. Each different substance within the target area produces a distinctive spectrum that can be sorted and stored for comparison during subsequent analyses of known or unknown materials.

UV to NIR EPS does have some drawbacks. First, it can be affected by interference (or clutter). Interference is defined as unwanted UV to NIR flux reaching the detector that does not contribute directly to the identification of a material of interest. For example, when attempting to detect illegal substance on clothing, clutter can arise from exciting unimportant molecules in the target area, exciting materials close to the detector/emitter region, external flux from outside the target area (including external light sources like room lights or the sun) and scattering from air and/or dust in the light path. Thus, one goal of the invention is enabling efficient and accurate discrimination between all these and other sources of interference in conjunction with an appropriate analysis system (using specific algorithms, spectral filtering, and/or modulation of the light source in conjunction with some form of synchronous detection).

UV to NIR EPS systems are also limited in terms of sensitivity distances. Greater distances between the substance of interest and the UV to NIR excitation source and detector result in weaker return photon flux (i.e., weaker, if any, EPS) from the sample material. The invention can utilize a form of bandwidth-limited synchronous detection and spectral bandwidths optimized for the particular substance of interest to improve the signal to noise ratio for detection of trace quantities of materials. Factors influencing the range and sensitivity include integration time, receiving optics aperture, optical system efficiency, source power, detector sensitivity, spectral bandwidth of the receiving spectrograph, light absorption efficiency, and the characteristics of the path through which the light travels.

The UV to NIR technology described here is valuable for measuring trace amounts of materials on surfaces, as well as below surfaces that are UV to NIR transmissive (e.g., plastic liquid containers, bottles). Using UV to NIR energy sources, the capability to detect a number of substances critical to homeland security, e.g, methamphetamine, cocaine, heroin, marijuana, TATP, TNT, RDX, C4, PETN, Black Powder, Smokeless Powder, A.N.F.O., Semtex, and Tetryl, has been demonstrated. This technology has also demonstrated the capability of distinguishing between the substances and their respective constituents, e.g., this technology can uniquely identify the presence of TATP but can be adjusted so as not to alert on constituent ingredients such as hydrogen peroxide, sulfuric acid or acetone. In this regard, the UV to NIR detection does not depend on any coexisting materials being present within the substance being detected.

Conventional spectroscopy and detection techniques include, among other things, neutron activation analysis, ultraviolet absorption, ion mobility spectroscopy, scattering analysis, nuclear resonance, quadrupole resonance, near infrared (NIR) reflectance spectroscopy, selectively-absorbing fluorescent polymers, and various chemical sensors. Each of these methodologies, however, suffers from deficiencies. For example, neutron activation analyses, while capable of directly measuring ratios of atomic constituents (e.g., hydrogen, oxygen, nitrogen, and carbon) require bulky energy sources that have high power demands and thus do not lend themselves to handheld instruments. Traditional UV to NIR absorption and scattering techniques are subject to high degrees of inaccuracy (i.e., false alarms and omissions) absent sizeable reference resources and effective predictive analysis systems. Scattering analysis techniques suffer similar shortcomings.

Ion mobility spectroscopy devices are currently in use at many airports for “wiping” analysis, but suffer from low sensitivities in practical measuring scenarios and have high maintenance demands. Resonance Raman is an emerging and promising technology, but requires special surfaces and sample preparation for operation. Quadrupole resonance techniques offer a good balance of portability and accuracy, but are only effective for a limited number of materials (i.e., they have an extremely small range of materials they can reliably and accurately detect); these systems also suffer from outside interfering radio frequency sources such as terrestrial radio broadcast stations. Finally, chemical sensors such as conventional NIR devices, while very accurate, are slow acting, have extremely limited ranges, and are too bulky for convenient handheld operation. Furthermore, chemical vapor sensors do not always produce consistent results under varying environmental conditions (e.g., high humidity and modest air currents) when substantial standoff distances are involved.

### SUMMARY OF THE INVENTION

The invention relates generally to the field of substance and material detection, inspection, and classification at wavelengths between approximately 200 nm and approximately 1800 nm. In particular, a handheld Enhanced Photoemission Spectroscopy (“EPS”) detection system with a high degree of specificity and accuracy, capable of use at small and substantial standoff distances (e.g., greater than 12 inches) is utilized to identify specific controlled substances and their mixtures in order to provide information to officials so that determinations can be made as to the legality and/or hazardous nature of such substance(s).

Thus, the invention relates to a handheld system, process, and method for material detection, inspection, and classification. In particular, the invention includes a miniature electronic scanning detection system (e.g, an EPS spectrograph) with a high degree of specificity and accuracy, operating generally in the ultraviolet to near infrared portion of the electromagnetic spectrum that is used to identify specific individual and unique mixtures of substances (including remote, real-time measurements of individual chemical species in complex mixtures). The unique spectral emissions, a small sample of which are shown in Table 1, from common controlled substances that allow the process to be applied to materials such as narcotics, illicit drugs, explosives, and toxic chemicals have also been observed with models of this instrument. The substances may additionally include food types, synthetic drugs, prescribed narcotics, liquids, powders and the like.

TABLE 3
Some Typical Substances and their Photoelectric Emissions

| Substance | Excitation(nm) | Emission Range (nm) | |
|---|---|---|---|
| TNT | 258/260 | 413/418 | emi |
| C4 | 260/350 | 400 single/400 double emi | |
| NH₄NO₃ | 380 | 685 | emi |
| RDX | 400 | 847 | emi |

| | | |
|---|---|---|
| Methamphetamine, pure | 271 | 282 ± 5 |
| Methamphetamine, street | 271 | 282 ± 5 |
| Cocaine, pure | 271/263 | 316 ± 35 |
| Cocaine, street (ry) | 271/263 | 316 ± 35 |
| Heroin | 271 | 329 ± 22 |
| Marijuana seed (columb | 310 | 398 ± 36 |
| gold) | | |

The invention provides a highly specific detection approach that directly addresses two major classes of technical challenges: (1) standoff detection of low levels of substance deposition on or under a variety of surfaces in highly variable circumstances with (2) an extremely low false alarm rate.

Miniaturizing an EPS detection system to a handheld unit sizes involves significant technological and engineering improvements over presently available spectrometer systems and light sources. For example, recently developed and commercially available light emitting diodes (LED's) can provide the necessary illumination and a bandpass filter of the proper wavelength can be utilized in front of the LED, so that only the molecules of interest are excited (the physical beam pattern of these LED's is such that two LED's, rotated so that their beam patterns are orthogonal to other, may be used for uniform illumination of the target of interest). Additionally, the miniaturization of spectrometer components usually reduces overall sensitivity, so in order to increase the system sensitivity to the required level for trace detection of materials, a low-pass spectral filter (such as that illustrated herein) can be introduced into the receiving optical path prior to the spectrometer. This introduction of a low-pass spectral filter reduces unwanted light from the external environment, e.g., sunlight reduction for the UV implementation of this invention, as well as narrows the spectral bandwidth to improve the signal to noise ratio. Increases in signal to noise ratio can also be realized from suitable digital filtering techniques. Additionally, modulating the light source(s) and utilizing phase sensitive (synchronous) detection along with advanced algorithms further improves the signal to noise ratio, which is directly related to the limit of minimum detection as well as the false positive rate. Improved signal to noise ratios, along with additional signal processing (algorithms include, but are not limited to, correlation, matched filters, mean squared error, and likelihood ratio comparisons) enhances detection as well.

The invention includes a handheld EPS detections system including (a) a miniature scanning detection system operating in the ultraviolet to near infrared portion of the electromagnetic spectrum that includes (i) an excitation light source; (ii) a bandpass filter; (iii) a low-pass spectral filter; and (iv) an ultraviolet fluorescence detector; (b) a processor coupled to the ultraviolet fluorescence detector, the processor receiving spectral data from the ultraviolet fluorescence detector; and (c) a database coupled to said processor that includes signature data for a plurality of predetermined chemical substances.

In another aspect, the invention includes an EPS detection system that can include a concentrator including a vacuum device (e.g., portable vacuum cleaner) operatively coupled to the EPS detections system with filter material over the intake to draw particles from the environment surrounding the area of interest and where a filter is then used as the target. This arrangement facilitates detection of airborne particles of the material of interest.

In another aspect, the EPS detection system of the invention emits light from single or multiple light sources, such as from an LED, laser, laser diode or flashlamp, to excite emission in different substances as well as exciting different emissions in the same substance. The light source may be pulsed, square-wave modulated, and/or continuous wave and may include single and/or multiple sources for complete scene illumination (e.g., rotate LED's, etc.).

In another aspect, the EPS detection system of the invention gathers spectral signatures with a spectrally selective detector, including, for example, conventional spectrometers, spectrally filtered photodetectors, spectrometers using Multimodal Multiplex Spectroscopy™ (licensed from technology owner), or any other form of spectral detection.

In another aspect, the EPS detection system of the invention digitizes the obtained spectral signatures.

In another aspect, the EPS detection system of the invention applies unique algorithms for signal processing, including, but not limited to, embedded processors using filtered FFT, synchronous detection, phase-sensitive detection, digital filters unique to each particular substance being detected. It is important to note that one, two, or all three physical processes (photoemission, Raman scattering, or specular reflection or absorption) may be present in a particular detection scenario. When only total return energy in a specific band of wavelengths is being utilized to detect the target material, then all three processes produce the total measured spectral energy in the wavelength band and the total return signal amplitude in a range of wavelengths can produce the desired signal for analysis and display. When more specificity is required, a frequency-space data transformation following digitization (e.g., FFT) allows the influence of each of the three processes to be separated by examining the individual coefficients of the transform series. Since certain coefficients are affected more by one process than another in this type of transform, deconvolution of the process creating the overall spectrum is possible.

In another aspect, the EPS detection system of the invention uses algorithms to compare the obtained spectral signatures to a database of known and/or previously obtained spectral signatures. These algorithms can include, but are not limited to, correlation, matched filters, mean squared error, or likelihood ratio tests.

In another aspect, the EPS detection system of the invention displays the obtained spectral signatures and/or the results of a comparison of the obtained spectral with signatures to a database of known and/or previously obtained spectral signatures.

In another aspect, the EPS detection system of the invention includes a handheld and/or battery operated device EPS detection device.

In another aspect, the EPS detection system of the invention includes a GPS locater internally mounted within the EPS detection system and/or in a handheld component of such system.

In another aspect, the EPS detection system of the invention determines the distance to target in order to keep the system within a sensitive range and could adjust the detection threshold as a function of distance.

In another aspect, the EPS detection system of the invention communicates wirelessly to a remote location.

In another aspect, the EPS detection system of the invention includes cell phone and/or other remote access communications capabilities, including video functions and storage.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates one embodiment of a handheld drug/materials detector of the invention;

FIG. 2 illustrates a low-pass spectral filter system that can be utilized in an embodiment of the invention, including in a hand held device;

FIG. 3 is a flow chart illustrating a process for matching measured EPS data with known signature spectra of certain compounds in accordance with an embodiment of the invention;

FIG. 4 illustrates a UV Spectrum of C4 Explosive as determined with a UV absorption detection system in accordance with an embodiment of the invention;

FIG. 5 illustrates a UV Spectrum of cocaine as determined with a UV absorption detection system in accordance with an embodiment of the invention;

FIG. 6 illustrates a UV Spectrum of TATP Explosive as determined with a UV absorption detection system in accordance with an embodiment of the invention; and

FIG. 7 illustrates a UV Spectrum of TNT Explosive (U.S.) as determined with a UV absorption detection system in accordance with an embodiment of the invention.

The UV illustrations used here in no way limit the invention to that part of the electromagnetic spectrum.

### DETAILED DESCRIPTION OF THE PREFERRED EMBODIMENTS

Reference will now be made in detail to the preferred embodiments of the invention. This invention may, however, be embodied in many different forms and should not be construed as limited to the embodiments set forth herein. In addition and as will be appreciated by one of skill in the art, the invention may be embodied as a product, method, system or process.

The invention relates to a system and methods for material detection, inspection, and classification. In particular, an electronic scanning detection system (e.g., an EPS spectrograph) with a high degree of specificity and accuracy, operating in the ultraviolet to near infrared portion of the electromagnetic spectrum, is used to identify specific individual and unique mixtures of substances (including remote, real-time measurements of individual chemical species in complex mixtures). Preferably, the substances identified by the invention are exposed medications and/or explosive and/or illegal materials that are not otherwise labeled or hidden within a sealed, opaque container. Certain embodiments of the invention, however, may be able to detect substances in a cup, bottle, or other container. This feature may be desirable for quality assurance programs to evaluate and monitor substances before leaving a manufacturing facility or pharmacy prior to delivery.

The invention may be configured in any number of ways, including as a hand-held device, a mobile device and/or fixed mounted device. In one embodiment, the invention is capable of electronically scanning substances directly or of receiving data from an accessible scanning device.

In one embodiment, identification of a substance includes analysis of the substance's electromagnetic spectrum. A generated spectrum can be cross-correlated and analyzed by comparison against other known reference information (e.g., other drugs or substances being administered to a patient in view of known genetic or health factors, known drug interactions and/or quality assurance information). The invention is applicable without changing the physical appearance or chemical composition of the substances. No single unique identifiers are required as part of the described process.

The invention has an extensive number of applications. A non-exclusive list includes, but is not limited to: any industries, processes and/or equipment requiring remote, non-invasive sensing of multiple chemical compounds or constituents (such as monitoring, commercial drug quality control and/or medication dispensing verification).

Reliable detection of trace amounts of controlled substances is required in a variety of settings because the raw ingredients to manufacture these substances are widely available, and currently no detection exists that is rapid, non-contact, and handheld.

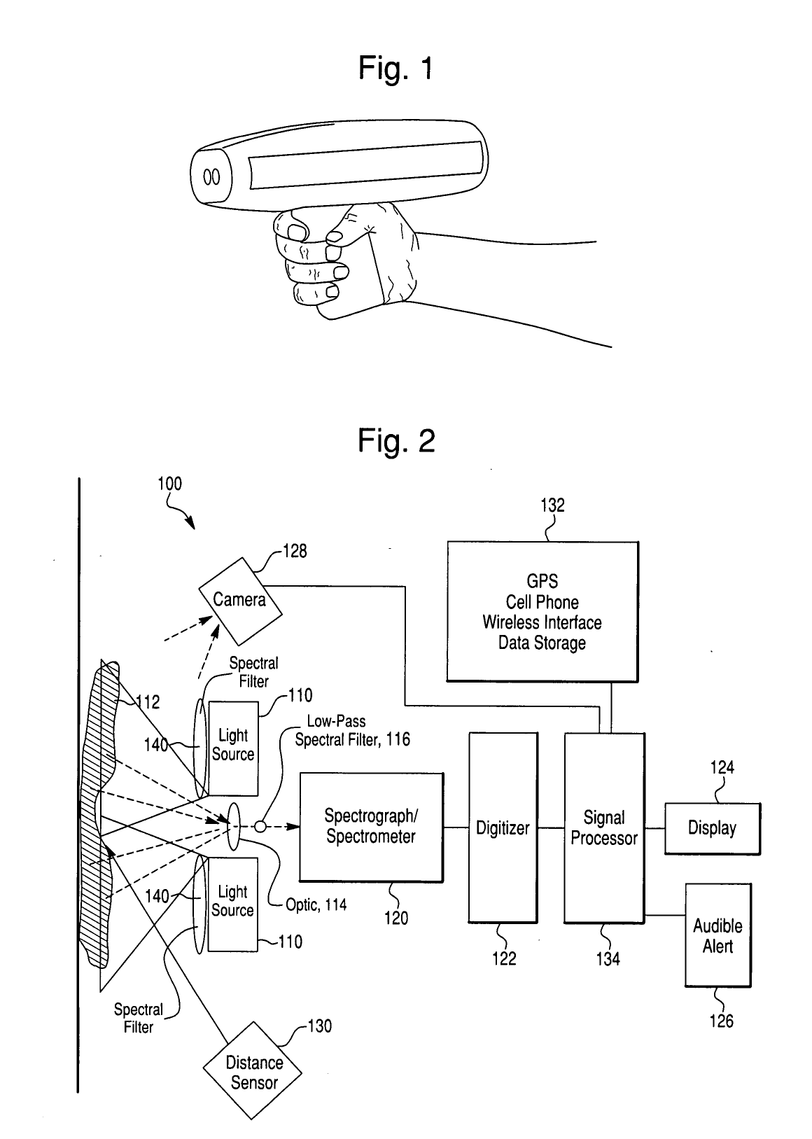

The illicit drug detection system shown in FIG. 1 includes a miniature flash lamp with spectral filtering to provide the appropriate excitation energy to induce (simultaneously) photoemission, Raman scattering, and NIR absorption/reflection in the target. The current excitation energy source functions well for detection out to approximately 2 inches from the front of the prototype with an effective detection footprint of approximately 1 inch (diameter).

In order to improve the standoff distance and the size of the footprint of the detector, a source with more effective power in the required excitation spectral band will be used. Candidates include lasers, laser diodes, light emitting diodes, and more powerful flash lamps. Commercial light emitting diodes (LED's) are beginning to be available that can provide energy on the target that is approximately 100 times greater than the energy source than is presently used in the detector illustrated in FIG. B. As such, the same detection threshold that is used in the present detector can be maintained while increasing the standoff distance from approximately 2 inches to approximately 12 inches and the effective detection footprint can be increased from approximately 1 inch to approximately 2¾ inches.

In FIG. 1, detection of the return photoemission is currently accomplished using a miniature custom spectrometer. While this approach allows straightforward re-configuration to detection of emission from additional substances at other wavelengths, several other schemes can provide sufficient spectral detection include individual photodiode detector/spectral filter combinations as well as lower cost and smaller size spectrometer designs. The resolution of the current spectrometer is greater than is required for this application, so the spectrometer approach may prove viable in a lower-resolution version.

The invention can include any known scanning device or combinations thereof. Computer and control electronics can also be connected to or used in tandem with the invention.

The invention includes a handheld EPS detections system including (a) a miniature scanning detection system operating in the ultraviolet to near infrared portion of the electromagnetic spectrum that includes (i) an excitation light source; (ii) a bandpass filter; (iii) a low-pass spectral filter; and (iv) an ultraviolet fluorescence detector; (b) a processor coupled to the ultraviolet fluorescence detector, the processor receiving spectral data from the ultraviolet fluorescence detector; and (c) a database coupled to said processor that includes signature data for a plurality of predetermined chemical substances.

In another embodiment, the invention can include an optical scanning device, a spectrograph (if this technique is used), a detector and an energy source.

In another embodiment, the invention may include a scanning device that is portable and/or that has no input keyboard or monitor screen. In this embodiment, the scanning detection device communicates using an input spectrograph and an output of a series of lights (e.g., green, yellow, amber, red) mounted on the scanning device.

In one aspect, the invention includes an EPS detection system that can include a concentrator for airborne materials consisting of vacuum device (e.g, portable vacuum cleaner) operatively coupled to the EPS detections system with filter material over the intake to draw particles from the environment surrounding the area of interest and where a filter is then used as the target.

In another aspect, the EPS detection system of the invention emits light from single or multiple light sources, such as from an LED, laser, laser diode or flashlamp, to excite emission in different substances as well as exciting different emissions in the same substance. The light source may be pulsed, square-wave modulated, and/or continuous wave and may include single and/or multiple sources for complete scene illumination (e.g., rotate LED's, etc.).

In another aspect, the EPS detection system of the invention gathers spectral signatures with a spectrally selective detector, including, for example, conventional spectrometers, spectrally filtered photodetectors, spectrometers using Multimodal Multiplex Spectroscopy (licensed from technology owner), or any other form of spectral detection.

In another aspect, the EPS detection system of the invention digitizes the obtained spectral signatures.

In another aspect, the EPS detection system of the invention applies unique algorithms for signal processing, including, but not limited to embedded processors using filtered FFT, synchronous detection, phase-sensitive detection, digital filters unique to each particular substance being detected.

In another aspect, the EPS detection system of the invention compares the obtained spectral signatures to a database of known and/or previously obtained spectral signatures.

In another aspect, the EPS detection system of the invention displays the obtained spectral signatures and/or the results of a comparison of the obtained spectral with signatures to a database of known and/or previously obtained spectral signatures.

In another aspect, the EPS detection system of the invention includes a handheld and/or battery operated device EPS detection device.

In another aspect, the EPS detection system of the invention includes a GPS locater internally mounted within the EPS detection system and/or in a handheld component of such system.

In another aspect, the EPS detection system of the invention determines the distance to target in order to keep the system within a sensitive range.

In another aspect, the EPS detection system of the invention communicates wirelessly to a remote location.

In another aspect, the EPS detection system of the invention includes cell phone and/or other remote access communications capabilities.

In general, the invention provides a mechanism for collecting unique “fingerprint” identifications (i.e., gathers information such that the fingerprint may be determined in a timely manner) of target materials that are used to distinguish them from other similar substances without prior knowledge of the substance (i.e., no single “unique identifiers” required). The fingerprint may include any quantifiable characteristic(s) pertaining to the substance, such as excitation wavelengths, barcodes, electronic signatures, and the like, negating any requirement for a single unique identifier. The invention can also include an accessible database of known characteristic(s) pertaining to certain agents and substances. An accessible computer system or other storage means enables the time, place and type of substance administered to be documented.

In one embodiment of the invention, a broadband source is used to generate EPS within a target area causing detectable emission at UV to NIR wavelengths that can be uniquely matched to known materials.

In another embodiment of the invention, the system can be used to simultaneously evaluate a group of different substances' for example, methamphetamine and TATP explosive. In this embodiment, the operator can be permitted to manipulate a combined spectrum of a group of different powders, or other chemical substances, and use the combined spectra to identify unauthorized or inappropriate variations. Such variations can include dangerous mixtures of partially completed mixes or additions and/or quality control verifications. Spectra of individual substances can also be combined to identify specific substances such as pharmaceuticals and explosives.

In accordance with another embodiment of the invention, the detection of emission photons is accomplished with a receiver that includes optics, a spectrograph, and a detector array. The system can further include an analysis system that identifies particular substances of interest.

In another embodiment, the invention preferably operates within the UV to NIR radiation wavelength range of approximately 200 nanometers to approximately 1800 nanometers. The invention is, however not limited to this wavelength range as the invention can operate within other wavelength ranges.

Multispectral excitation and/or detection is accomplished with the invention in a number of ways. Selection and control of either excitation wavelengths and/or detection wavelengths can be accomplished using, among other things, a pulsed power sources (e.g a sequence-pulsed laser system) in conjunction with data collection corresponding to each pulse, a spectral filter wheel(s) to select or vary different excitation or detection wavelengths and combinations thereof. The commercial availability of LED's allows miniaturization and power consumption optimization of the handheld system.

The sensitivity of the invention can be further enhanced by use of a low-pass spectral filter system, such as the system 100 illustrated in FIG. 2 and which can be utilized in one embodiment of the invention, including in the hand held device of FIG. 1. In particular, FIG. 2 illustrates the use of shutters and/or mechanical baffles minimizes extraneous light sources by selectively limiting access of extraneous light (as well as excitation and emission light) to the detector. For example, a shutter may be triggered to open within a discreet period of time in conjunction with an excitation pulse in order to limit the interference effects of extraneous light sources.

In FIG. 2, excitation energy from one or more excitation (i.e., light) sources 110 is directed through a spectral filter 140 at a target material 112 in order to generate an emission. Emission energy from the targeted material is detected with an optic 114 and is then enhanced by a connected low-pass spectral filter 116 prior to being analyzed by a coupled spectrograph/spectrometer 120. After being analyzed by the connected spectrograph/spectrometer 120, the resulting data is processed and digitized with a digitizer 122 and is then imaged on a display 124 and/or is audibly reported (e.g., by a buzzer/audible device or a display light). The system illustrated in FIG. 2 can also include a camera 124 for visually recording the target material 112, a distance sensor 130 for measuring the offset distance of the device from the targeted material. The system can also include various communication devices 132 (e.g., a cell phone, GPS module, a wireless interface) as well as a data storage mechanism. The data collected in the system 100 of FIG. 2 can then be processed through a coupled signal processor 134.

Regardless of the particular configuration, the sensitivity limits of the system can depend on any of several factors. These factors can include: energy source availability, cross-section of photoelectric absorption, path length, detector collecting area, detector spectral resolution, detector geometrical characteristics, integration time, and detector noise limit. A number of steps have been taken to maximize these factors for detection.

In another embodiment of the invention, the detection system uses a continuous output deuterium ultraviolet source with narrow-band interference filter(s) to define the excitation spectral properties. In such an arrangement, the power density available at full output power is 1 mW/cm². The UV Tto VIS output is collected by a 3 cm² area lens and directed from the target area to the detection system. The lens collects energy from a concentrated illuminated spot (˜100 mm diameter) on a target at an approximately 300 mm standoff. In this embodiment, the cross-section of the target is optimized for photoelectric absorption by selecting a fixed spectral filter or by using a monochromator to provide the required excitation wavelength for each substance of interest in the target area. Simultaneously, a receiver comprising a spectrograph and light-sensitive detector views the target area. Thereafter, quick emission samples (or exposures) are recorded and the resultant spectra compared to a database of known substances. Using this system, detection sensitivities of approximately 100 nanograms/cm² with methamphetamine as the target have been achieved in a 2 inch diameter area at a standoff distance of 12 inches.

In another aspect, the invention also provides the ability to detect and analyze substances within target areas at substantial standoff distances whether in liquid, solid or gaseous form.

In another aspect, the invention can be adapted to be use in unique and varied system configurations (including critical component placement).

In another aspect, the invention includes the creation, update and maintenance of a database of unique signatures for individual and complex mixtures of substances. In this regard, the invention can utilize miniature spectrograph instruments coupled to detector arrays with high efficiency power capabilities and novel source optics design.

In another aspect, the invention can include hardware that can implement various incident power stabilization methodologies and improved analyses, including sample evaluations based on pulsed timing sequences as well as pulse-synchronization modes for operation in sunlight and room light environments.

In another aspect, the invention includes hand held devices for the detection of unknown substance, including, for example, methamphetamine and its chemical precursors. These embodiments of the invention have the general look and feel of a traffic radar gun, and enable real time detection of illicit drugs and illicit drug production. Detection of methamphetamine, for example, is accomplished by passing the spectral beam over a surface contaminated with trace quantities of methamphetamine. In this regard, the invention is well suited for addressing issues related to the illicit production and distribution of amphetamine and amphetamine-like substances. For example, illegal laboratories that manufacture methamphetamines are one of the greatest challenges facing law enforcement officers. Remediation of methamphetamine laboratories is a required step prior to permitting re-occupancy of the house or other contaminated structure where an illicit lab was located because residual chemicals may pose health concerns in residential structures even after the laboratory equipment has been removed.

The invention has an extensive number of applications. A non-exclusive list includes, but is not limited to: any industries, processes and/or equipment requiring remote, non-invasive sensing of multiple chemical compounds or constituents (such as in the chemical, petroleum and other similar industries, internal pollution and contamination controls, external pollution and contamination controls, illegal drug detection and monitoring, commercial drug quality control and dispensing verification, nuclear waste and effluent monitoring, air standards determination, explosives monitoring and detection, semiconductor industry effluent monitoring and control, hazardous waste and emission monitoring, semiconductor quality control measures, semiconductor processing contamination monitoring and control, plasma monitoring and control, waste dump site monitoring and control, nuclear, biological, and chemical weapons by-products monitoring, clean room monitoring and control, clean room tools monitoring, vacuum controls, laminar flow controls and controlled environments); security monitoring (including airport and transportation security, improvised explosive device (IED) detection, military and civilian ship and building security, drug (illegal and commercial) security, explosives, weapons and bio-hazard manufacture, detection and storage); remediation (including of hazardous and toxic materials, chemicals, buried land mines, unexploded ordinance, and other explosive devices).

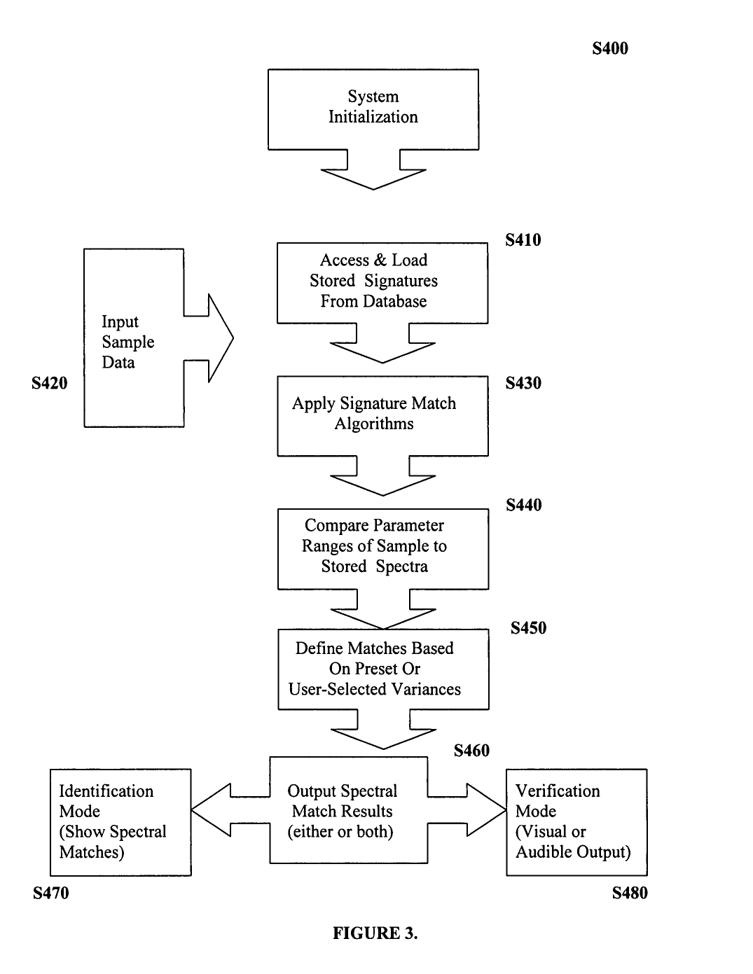

FIG. 3 is a flow chart illustrating a process for matching measured photoemission data with known signature spectra of certain compounds in accordance with an embodiment of the invention. In FIG. 3, the matching process begins at step S400 wherein the system is initialized. The process then moves to step S410 in which the system accesses and loads UV signatures from known materials that are stored on a system-accessible database. The process then moves to step S420 where the data from an evolving sample spectrum being acquired is supplied to the system. For example, this step may include receiving processed signals from a CCD and/or signal processor. In step S430 the system applies algorithms to the acquired sample data provided in step S420. This step can include, for example, application of a 20^{th} order power series of cosine functions for curve matching or an FFT analysis. Next, in step S440, the manipulated sample data from steps S420 and S430 is compared to the UV signatures loaded from the database in step S410. Step S440 can include, for example, using a least-square curve-fitting routine or FFT that reduces the measured spectrum to a small set of digital numbers sufficient to describe the key information contained in the spectrum, including using up to a 24^{th}-order equation to manipulate the digitized information (or its coefficients if transformed to frequency space by an FFT). In step S450, the system determines whether there has been a match based on the comparison procedure in step S440. A match can defined as a preset standard deviation between values from the sample spectrum and those of stored spectra, such as, for example, three standard deviations above or below a average value of a stored spectrum). Next, in step S460, the system outputs the results of any matches. Step S460 can include either (or both) of steps S470 (in which the system provides spectral results for visual inspection by the operator and/or provides overlays of the produced spectra) and step S480 (in which visual and/or audible alarms indicate a match).

Specific embodiments of the generalized UV absorption detection system of the invention have been used to obtain photoemission spectra for a number of materials including TNT (US), TNT (Russia), RDX, PETN, C4, cocaine, heroin and 27 commercial drugs. FIGS. 3-6 are representative of such spectra and are for illustrative purposes only and are not intended nor should they be interpreted to limit the scope of the application.

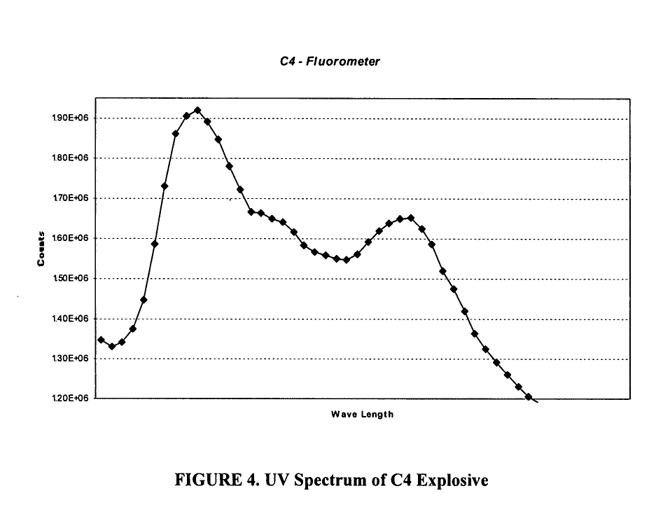

FIG. 4 illustrates the UV Spectrum of C4 Explosive as determined with a UV absorption detection system in accordance with an embodiment of the invention.

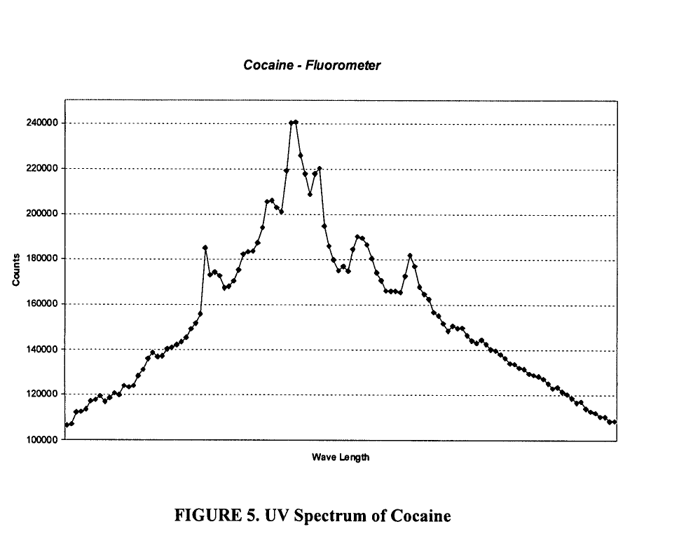

FIG. 5 illustrates the UV Spectrum of cocaine as determined with a UV absorption detection system in accordance with an embodiment of the invention.

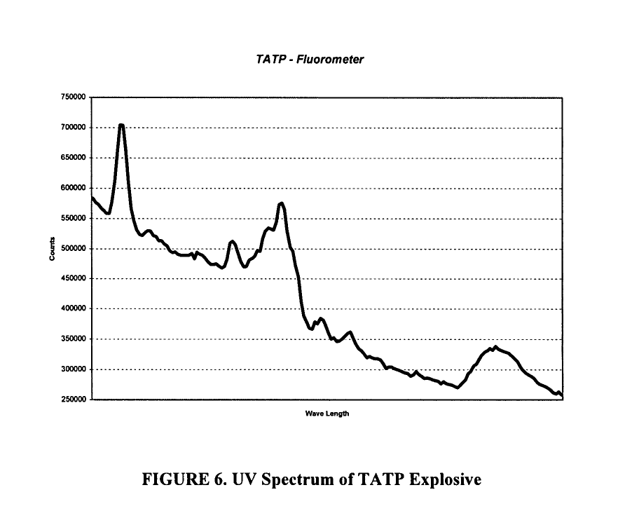

FIG. 6 illustrates the UV Spectrum of TATP Explosive as determined with a UV absorption detection system in accordance with an embodiment of the invention.

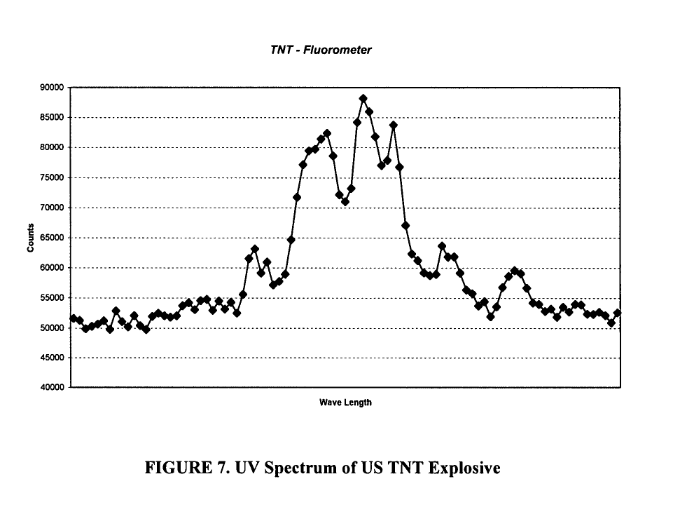

FIG. 7 illustrates the UV Spectrum of TNT Explosive (U.S.) as determined with a UV absorption detection system in accordance with an embodiment of the invention.

Modifications and variations of the invention are possible and envisioned in light of the above descriptions. It is therefore to be understood that within the scope of the attached detailed description, examples and claims, the invention may be practiced otherwise than as specifically described.

### SPECIFIC EXAMPLES

### Example 1

In one embodiment, the invention can include a scanning device that can be used to scan a region of suspected illicit substance. In this embodiment, the invention identifies any negative or potentially hazardous or combinations of hazards. When configured in this manner, the invention can scan single or multiple surfaces simultaneously and thereafter generate a combined spectrum that can be marked indicating potentially adverse and/or acceptable conditions. The disclosed embodiment may also (or alternatively) provide other visible or audible indications of potentially adverse and/or acceptable conditions (e.g., illuminating a red light for a dangerous condition or a green light for an acceptable condition).

### Example 2

In another embodiment, the invention can include a scanning device that can be configured as a portable, stand-alone device that can test for dangerous chemicals and/or chemical combinations. The scanning device can optionally be configured as a self-contained scanning and diagnostic unit thus alleviating the need to be coupled to a central processing or computer unit.

### Example 3

In another embodiment, the invention can include a scanning device that includes a detached and/or transitional product from a chemical identification system that individually identifies unknown pills and/or chemicals contained in a mixture and provides discreet information regarding each constituent.

### Example 4

In another embodiment, the invention can be used at locations that are not linked to centralized computer systems to detect and monitor potential hazardous materials such as at a crime scene or at other locations.

### Example 5

In another embodiment, the invention can include a learning function enabling the user to add substances to a mixture spectra after determining there are no dangerous conditions.

### Example 6

In another embodiment, the invention can be linked to a central computer system that enables it to access a large database of material spectra. Thereafter, the invention can calculate a combined spectrum, detect potential hazardous conditions and/or assess compliance following cleanup of hazardous materials or other contaminations, such as at a clandestine drug lab, improvised explosives manufacturing location, etc.

### Example 7

In another embodiment, the invention can utilize a deconvolving computational process to assess potential hazardous materials.

### Example 8

In another embodiment, the invention may be used in conjunction with, and as part of, chemical or production quality assurance applications and protocols.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

What is claimed is:

1. A handheld photoemission spectroscopy detections system comprising:
a. a miniature scanning detection system operating in the ultraviolet to near infrared portion of the electromagnetic spectrum comprising:
i. an excitation light source;
ii. a bandpass filter;
iii. a low-pass spectral filter;
iv. an ultraviolet fluorescence detector;
b. a processor coupled to the ultraviolet fluorescence detector, the processor receiving spectral data from the ultraviolet fluorescence detector; and
c. a database coupled to said processor that includes signature data for a plurality of predetermined chemical substances.

2. The system of claim 1, wherein said excitation light source comprises at least one of a light emitting diode a laser, a laser diode, a flashlamp and combinations thereof.

3. The system of claim 1, wherein said excitation light source comprises at leased one of a pulsed light source, a square-wave modulated light source, a continuous wave light source and combinations thereof.

4. The system of claim 1, wherein said ultraviolet fluorescence detector comprises at least one of a spectrometer, a spectrally filtered photodetectors, and combinations thereof.

5. The system of claim 1, further comprising a concentrator comprising a vacuum device operatively coupled to said system.

6. The system of claim 1, further comprising a GPS locater.

7. The system of claim 1, wherein said system has a functional standoff distance of approximately 2 inches to approximately 12 inches.

8. The system of claim 1, wherein said system has a measurement footprint of approximately 1 inch to approximately 2.75 inches.

9. The system of claim 1, wherein said system communicates wirelessly with at last one remote location.

10. The system of claim 9, wherein said at least one remote location houses at least one of said processor coupled to the ultraviolet fluorescence detector and said database coupled to said processor.

11. The system of claim 1, further comprising at least one remote access communication device.

12. The system of claim 1, wherein said system determines the distance to a target in order to keep said system within a sensitive range.

13. The system of claim 1, further comprising at least one of optics, a spectrograph and a detector array.

14. The system of claim 1, wherein said system operates with a radiation wavelength range of approximately 200 nanometers to approximately 1800 nanometers.

15. The system of claim 1, wherein said system is used to detect at least one of methamphetamine, cocaine, heroin, marijuana, TATP, TNT, RDX, C4, PETN, Black Powder, Smokeless Powder, A.N.F.O., Semtex, Tetry and combinations thereof.

16. Use of the system of claim 1 for at least one of detecting multiple chemical compounds or constituents in the chemical or petroleum industries; measuring internal pollution and contamination controls; measuring external pollution and contamination controls; illegal drug detection and monitoring; commercial drug quality control and dispensing verification; nuclear waste and effluent monitoring; air standards determination; explosives monitoring and detection; semiconductor industry effluent monitoring and control; hazardous waste and emission monitoring; semiconductor quality control measurement; semiconductor processing contamination monitoring and control; plasma monitoring and control; waste dump site monitoring and control; nuclear, biological, and chemical weapons by-products monitoring; clean room monitoring and control; clean room tools monitoring; vacuum control monitoring; laminar flow control monitoring; security monitoring; military and civilian ship and building security; drug security monitoring; explosive monitoring; weapons and bio-hazard manufacturing, detection and storage; and remediation.
